(19) United States
(12) Patent Application Publication
(10) Pub. No.: US 2026/0322627 A1
(43) Pub. Date: Oct. 15, 2026

(54) USER DEVICE INTERACTION PROCESSING SYSTEM AND METHOD

(71) Applicant: Visa International Service Association, San Francisco, CA (US)

(72) Inventors: Yuexi Chen, Foster City, CA (US); Bharatkumar Patel, Singapore (SG); Bryan Wang, San Francisco, CA (US); Jennifer Kim Astrein, San Francisco, CA (US); Pawel Chrobok, Alameda, CA (US); Shamit Bhatia, New York, NY (US); Hadi N. Raad, Dubai (AE); Osman Shareef, San Mateo, CA (US); Sirajuddin Nazir, Dublin, CA (US); Hans Kullberg, San Diego, CA (US); Geraldine Mitchley, Oakland, CA (US)

(73) Assignee: Visa International Service Association, San Francisco, CA (US)

(21) Appl. No.: 19/483,938

(22) PCT Filed: May 29, 2024
(86) PCT No.: PCT/US2024/031412

§ 371 Date: Nov. 12, 2025

Related U.S. Application Data
(60) Provisional application No. 63/504,934, filed on May 30, 2023.

(51) Int. Cl. H04L 9/32; G06F 21/60

(52) U.S. Cl. CPC H04L 9/3268; G06F 21/606

(57) ABSTRACT

A method includes providing, by a user device, an API call from a resource provider application to a processing module on the user device. The API call includes application data for an interaction. The user device can prompt a user to bring a portable device into communication range with the user device, based on the application data. The user device can receive interaction data from the portable device. The user device can generate an authorization request message based on the application data and/or the interaction data, then provide the authorization request message to a processing system. The processing system can determine whether or not the interaction is authorized and generate an authorization response message comprising an indication of whether or not the interaction is authorized. The user device can receive the authorization response message. The user device can provide the indication from the processing module to the resource provider application.

### CROSS-REFERENCE TO RELATED APPLICATIONS

This application if a PCT application, which claims priority to U.S. Provisional Application No. 63/504,934, filed on May 30, 2023, which is herein incorporated by reference in its entirety.

### BACKGROUND

When performing an interaction for a resource that is to be delivered, a user will access a resource provider application on a user device. The user can select one or resources in the resource provider application. The resource provider application can then prompt the user to input interaction data or may already have the user's interaction data stored in the resource provider application. The resource provider application can then perform an interaction with the user's interaction data.

In other cases, the user can request a resource from a resource provider. Upon delivery of the resource, the user provides their interaction data to delivery personnel device or provides the user's payment device to the delivery personnel for processing. However, these present methods have various security flaws.

For example, the resource provider application may be a fraudulent application or may be associated with fraudulent websites. Furthermore, the delivery personnel device and/or the delivery personnel can attempt fraudulent interactions with the user, ranging from stealing the user's payment device to using a fraudulent mobile point-of-sale device to skim data from the user's payment device. As such, the user may not trust websites, resource provider applications, or delivery personnel with sensitive data. Furthermore, it is difficult to provide all delivery/service personnel with wireless POS hardware that is up to date, as any out-of-date hardware is further susceptible to security vulnerabilities.

Embodiments of the disclosure address this problem and other problems individually and collectively.

### SUMMARY

One embodiment is related to a method comprising: providing an API call from a resource provider application on the user device to a processing module on the user device, wherein the API call includes application data for an interaction; prompting, by the user device, a user to bring a portable device into communication range with the user device, based on the application data; receiving, by the user device, interaction data from the portable device; generating, by the user device, an authorization request message based on the application data and/or the interaction data; providing, by the user device, the authorization request message to a processing system, wherein the processing system obtains an authorization response message comprising an indication of whether or not the interaction is authorized; receiving, by the user device, the authorization response message; and providing, by the user device, the indication of whether or not the interaction is authorized from the processing module to the resource provider application.

Another embodiment of the invention is directed to a user device comprising: a processor; and a computer readable medium coupled to the processor, the computer readable medium comprising code, executable by the processor, to implement a method comprising: providing an API call from a resource provider application on the user device to a processing module on the user device, wherein the API call includes application data for an interaction; prompting a user to bring a portable device into communication range with the user device, based on the application data; receiving interaction data from the portable device; generating an authorization request message based on the application data and/or the interaction data; providing the authorization request message to a processing system, wherein the processing system obtains an authorization response message comprising an indication of whether or not the interaction is authorized; and receiving the authorization response message; and
providing the indication of whether or not the interaction is authorized from the processing module to the resource provider application.

These and other embodiments are described in further detail below.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of a user device according to embodiments.

FIG. 3 shows a diagram illustrating an interaction process according to embodiments.

FIG. 4 shows messages that can pass between a user device and a processing module in an interaction in an embodiment.

### DETAILED DESCRIPTION

Prior to discussing embodiments of the disclosure, some terms can be described in further detail.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin client device, a tablet PC, etc. Additionally, user devices may be any type of wearable technology device, such as a watch, earpiece, glasses, etc. The user device may include one or more processors capable of processing user input. The user device may also include one or more input sensors for receiving user input. There are a variety of input sensors capable of detecting user input. Exemplary input sensors include accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user” may include an individual. In some embodiments, a user may be associated with one or more personal accounts and/or mobile devices. The user may also be referred to as a cardholder, account holder, or consumer in some embodiments.

A “portable device” can include any suitable device that may be portable. A portable device may be in any suitable form. For example, suitable portable devices may be hand-held and compact so that they can fit into a consumer's wallet and/or pocket (e.g., pocket-sized). They may include smart cards (e.g., contactless smart cards), magnetic stripe cards, keychain devices (such as the Speedpass™ commercially available from Exxon-Mobil Corp.), etc. Other examples of portable devices include cellular phones, personal digital assistants (PDAs), pagers, payment cards, security cards, access cards, smart media, transponders, an electronic or digital wallet, wearable devices such as smart watches, fitness bands, ankle bracelets, rings, earrings, and the like. If the portable device is in the form of a debit, credit, or smartcard, the portable device can operate in either a contact or contactless mode. in some embodiments, a portable device may be used to conduct an interaction. For example, a portable device may be used to conduct a transaction, such as to provide payment information to a resource provider.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Interaction data” can include data related to and/or recorded during an interaction. Interaction data can be provided from a portable device to another device (e.g., a user device, an access device, etc.). Interaction data can be provided in one or more communications between a portable device and a user device (e.g., in one or more application protocol data units (APDUs)). For example, interaction data can be provided from a portable device to a user device in a select PPSe message(s), select AID message(s), get processing options (GPO) message(s), read record message(s), etc. In some embodiments, interaction data can include a primary account number (PAN), a token, a cryptogram, etc.

“Application data” can include data related to an application. For example, application data can include data related to a resource provider application on a user device (or other device). Application data can include identifiers, certificates, amounts, country codes, currency codes, API keys, and/or any other suitable data created by or utilized by an application.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a username, an expiration date, a CVV (card verification value), a dCVV (dynamic card verification value), a CVV2 (card verification value 2), a CVC 3 card verification value, etc. An example of a PAN is a 16-digit number, such as “4147 0900 0000 1234”. In some embodiments, credentials may be considered sensitive information.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval-- transaction was approved; Decline-- transaction was not approved; or Call Center-- response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “resource provider” may be an entity that can provide a resource such as goods, services, information, and/or access. Examples of resource providers includes merchants, data providers, transit agencies, governmental entities, venue and dwelling operators, etc.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

An “acquirer” may typically be a business entity (e.g., a commercial bank) that has a business relationship with a particular merchant or other entity.

Some entities can perform both issuer and acquirer functions. Some embodiments may encompass such single entity issuer-acquirers. An acquirer may operate an acquirer computer, which can also be generically referred to as a “transport computer.”

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

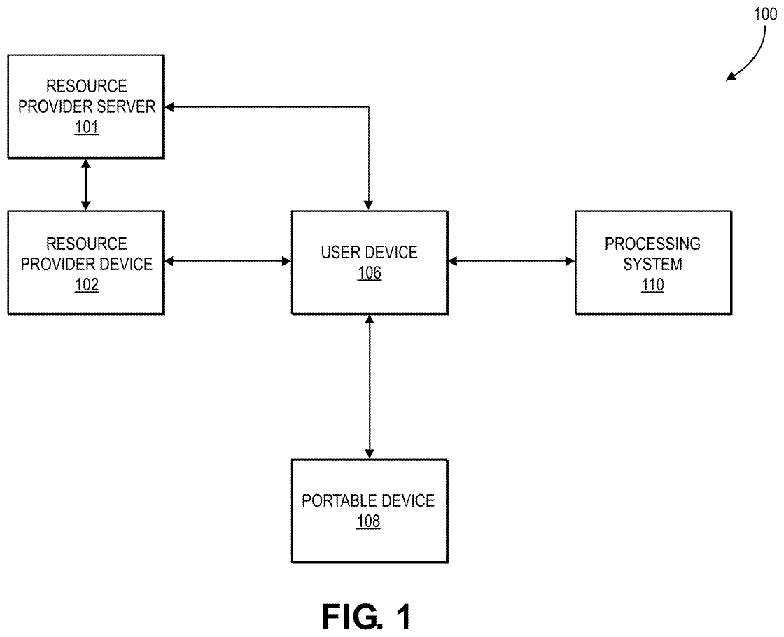

FIG. 1 shows a system 100 according to embodiments of the disclosure. The system 100 comprises a resource provider device 102, a resource provider server 104, a user device 106, a portable device 108, and a processing system 110. The resource provider device 102 can be in operative communication with the resource provider server 104 and the user device 106. The user device 106 can be in operative communication with the resource provider server 104, the portable device 108, and the processing system 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between at least the devices illustrated in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The resource provider device 102 can be a mobile device. In some embodiments, the resource provider device 102 can be operated by an entity associated with the resource provider. For example, the resource provider device 102 can be operated by a delivery person that can deliver resources for the resource provider. The resource provider device 102 can receive indications of whether or not an interaction between a user of the user device 106 and a resource provider of the resource provider server 104 is authorized. In some embodiments, upon receiving the indication of whether or not an interaction is authorized, the resource provider device 102 can prompt the delivery person to provide the resource(s) to the user of the user device 106.

The resource provider server 104 can be a server computer operated by a resource provider. The resource provider server 104 can communicate with a resource provider device 102 and one or more resource provider applications stored on the user device 106.

The user device 106 can be a mobile device operated by a user. The user device 106 can comprise one or more resource provider applications. The user can initiate an interaction with a resource provider using a resource provider application on the user device 106.

The portable device 108 can be, for example, a contactless payment card associated with the user of the user device 106. The portable device 108 can be configured to communicate with the user device 106 and can provide interaction data to the user device 106 via a short-range communication channel (e.g., Bluetooth, Bluetooth low energy (BLE), near-field communication (NFC), etc.).

The processing system 110 can be a system capable of processing an interaction. In some embodiments, the processing system 110 can comprise a kernel-in-the-cloud system. In other embodiments, the processing system 110 can comprise a gateway such as a transport computer, a network processing computer, and an authorizing entity computer. The processing system 110 can receive an authorization request message from the user device 106 and can determine (e.g., by an authorizing entity computer) whether or not the interaction is authorized. The processing system 110 can generate and provide an authorization response message to the user device 106. The authorization response message can include an indication of whether or not the interaction is authorized.

In some embodiments, the network processing computer in the processing system 110 may be part of a processing network computer configured to provide authorization services, and clearing and settlement services for payment transactions. The processing network computer may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services.

Furthermore, the payment processing network may include a server computer and may use any suitable wired or wireless telecommunications network, including the Internet. In some embodiments, the processing network computer may forward an authorization request received from the transport computer to the authorizing computer via a communication channel. The processing network computer may further forward an authorization response message received from the authorizing computer to the transport computer.

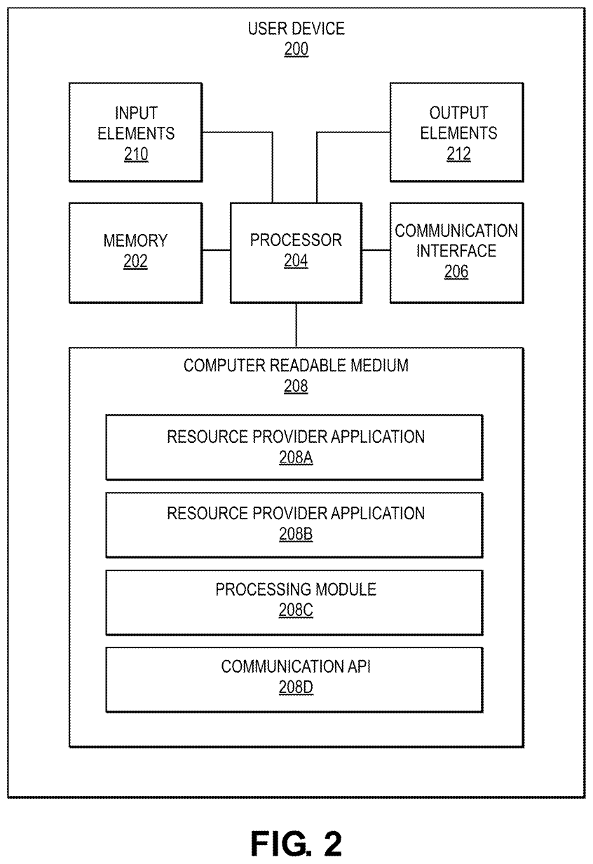

FIG. 2 shows a block diagram of a user device 200 according to embodiments. The exemplary user device 200 may comprise a processor 204. The processor 204 may be coupled to a memory 202, a communication interface 206, input elements 210, output elements 212, and a computer readable medium 208.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store interaction data, application data, etc.

The one or more input elements 210 may include any suitable device(s) capable of inputting data into the user device 200. Examples of input elements 210 include buttons, touchscreens, touch pads, microphones, etc.

The one or more output elements 212 may comprise any suitable device(s) that may output data. Examples of output elements 212 may include display screens, speakers, and data transmission devices. For example, the output elements 212 can include a display screen capable of displaying a response value to a user of the user device 200.

The computer readable medium 208 may comprise several software applications and/or software modules. Examples of such modules can include resource provider applications 208A, 208B, a processing module 208C, and a communication API 208D.

The computer readable medium 208 may comprise code, executable by the processor 204, for performing a method comprising: providing, by a user device, an API call from a resource provider application on the user device to a processing module on the user device, wherein the API call includes application data for an interaction; prompting, by the user device, a user to bring a portable device into communication range with the user device, based on the application data; receiving, by the user device, interaction data from the portable device; generating, by the user device, an authorization request message based on the application data and/or the interaction data; providing, by the user device, the authorization request message to a processing system, wherein the processing system obtains an authorization response message comprising an indication of whether or not the interaction is authorized; receiving, by the user device, the authorization response message; and providing, by the user device, the indication of whether or not the interaction is authorized from the processing module to the resource provider application.

The communication interface 206 may include one or more devices and software that can allow the user device 200 to communicate with external computers or devices. The communication interface 206 may enable the user device 200 to communicate data to and from another device (e.g., a resource provider device, a resource provider server, a portable device, a device, computer, and/or server of a processing system, etc.). Some examples of the communication interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the communication interface 206 may include Wi-Fi™. Data transferred via the communication interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the communication interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

In other embodiments, the communication interface 206 may also comprise a long range antenna. The long range antenna can allow the user device to communicate with remote server computers over the air (e.g., via a cellular communications network).

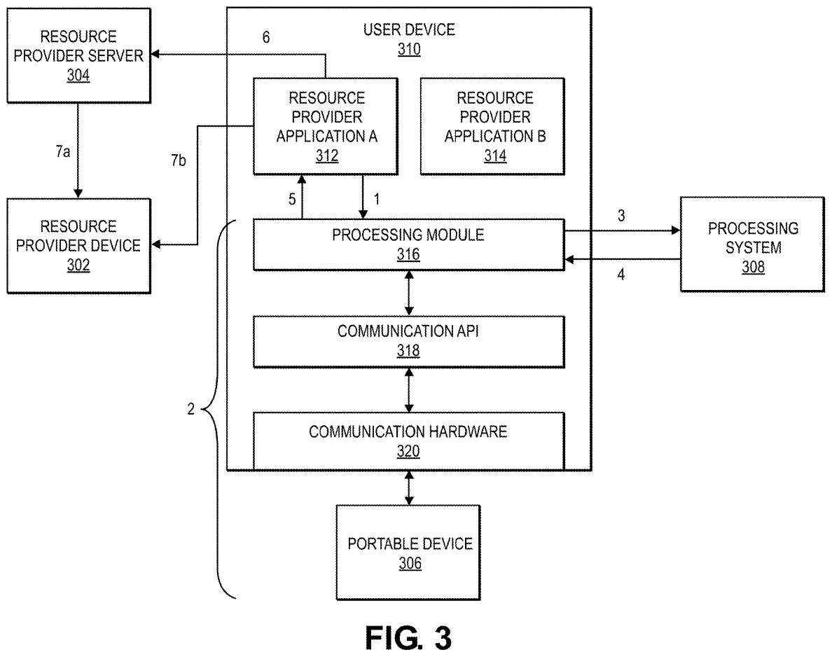

FIG. 3 shows a diagram illustrating an interaction process according to embodiments. The process illustrated in FIG. 3 will be described in the context of a user using a user device to interact with a resource provider operating a resource provider server. As an example, a user can use the user device to initiate a tap and pay portable device-present transaction using a resource provider application installed on the user device. It is understood, however, that the invention can be applied to other circumstances.

As noted above with respect to FIG. 2, a processing module 316 can be installed on a user device 310. The processing module 316 can be utilized by one or more resource provider applications installed on the user device 310. The one or more resource provider applications can include a resource provider application A 312 and a resource provider application B 314. One two resource provider applications are shown for clarity of illustration. Embodiments can include additional resource provider applications.

In some embodiments, the processing module 316 can be a kernel-on-device (KoD) service. A KoD service can include a contactless entry point, contactless kernel(s), cardholder verification method (CVM) module(s), a payment card data encryption module, and/or other software modules that can be utilized for an interaction (e.g., a contactless payment transaction). In some embodiments, the processing module 316 can be a thin client (TC) service, where the TC service can include a rules engine, a scripts engine, and/or rules retrieved from a connected kernel-in-cloud (KiC) server (e.g., of the processing system 308). The processing module 316 can be in the form of an SDK (software development kit), which can be integrated with a wallet application on the user device 310.

The thin client service can include the following components: (1) a submodule that manages security and a Representational State Transfer (REST) API, and a HTTP interface. This includes establishing a secure channel with a server, device attestation, retrieval of system configuration information and handling use case specific REST payload requests and responses with the backend server; (2) a Communication Abstraction Layer (CAL)—e.g., an EMV (Europay MasterCard, Visa) 2nd Gen defined module for managing the communication protocol(s) with portable devices such as payment instruments; and (3) one or more Script Engines executing specific scripts applicable to each of the local interfaces supported by the thin client, such as an ISO 7816-4 APDU interface for Contactless/NFC protocols.

The thin client configuration can be synchronized with a backend configuration, namely, with respect to sets of executable scripts, and a data mapping table for EMV Tags where applicable.

The processing module 316 can expose APIs to resource provider applications (e.g., 312, 314) on the user device 310 for interactions (e.g., transactions, contactless EMV card present transactions, etc.). The resource provider application can provide application data to the processing module 316 via an API call. The API can be implemented in various ways (e.g., Android Service API, Android Intent, etc.). As an example, an API call from the resource provider application A 312 to the processing module 316 can be as follows: public int performEMVContactless Transaction(String strMerchantIdentifier (a merchant identifier), String sreMerchantCertificateBase64 (a merchant certificate), int iTransactionAmount (a transaction amount), int iCountryCode (a country code), int iCurrencyCode (a currency code)).

In some embodiments, a resource provider application can provide credentials (e.g., an API key, digital certificate) to the processing module 316 when calling the API. The resource provider application credentials can indicate that the resource provider application is allowed to access the processing module 316. For example, an authorized resource provider application may have a shared secret, an API key or resource provider digital certificate that is validated by the processing module 316, before the processing module 316 will interact further with the resource provider application. The processing module 316 could have or create the shared secret or API key, and compare it to the received shared secret or API key to authenticate the resource provider application. Alternatively, or additionally, the processing module 316 can use a public key associated with a digital certificate to validate a digital signature provided by the resource provider application and/or communicate with an external server to determine if the digital certificate is genuine and valid. By authenticating and validating the resource provider application before interacting with it, the processing module 316 can ensure that any interaction being conducted with it is authentic.

At step 1 of FIG. 3, the resource provider application A 312 can call the processing module 316 API to initiate an interaction (e.g., a card present transaction) on the user device 310 by providing resource provider application authentication data such as an API key and/or digital certificate, and application data including, for example, merchant ID, transaction amount, currency code, and country code.

In some embodiments, prior to step 2, the processing module 316 can request a configuration associated with, for example, the merchant ID received in the application data. The processing system 308 can provide the configuration to the processing module 316. The configuration can include details related to the resource provider's interaction processing capabilities, preferences, selections, etc. For example, the configuration can indicate whether or not the resource provider supports interactions with interaction data associated with particular locations, entities, currencies, etc.

After on the resource provider application call, the processing module 316 can validate the resource provider application authentication data as described above. If the resource provider application is authenticated, the processing module 316 can prompt the user to tap a portable device 108 against communication hardware 320 of the user device 310. The communication hardware 320 can include, for example, an NFC antenna. The prompt to the user of the user device 310 can be via a speaker or display in the user device 310.

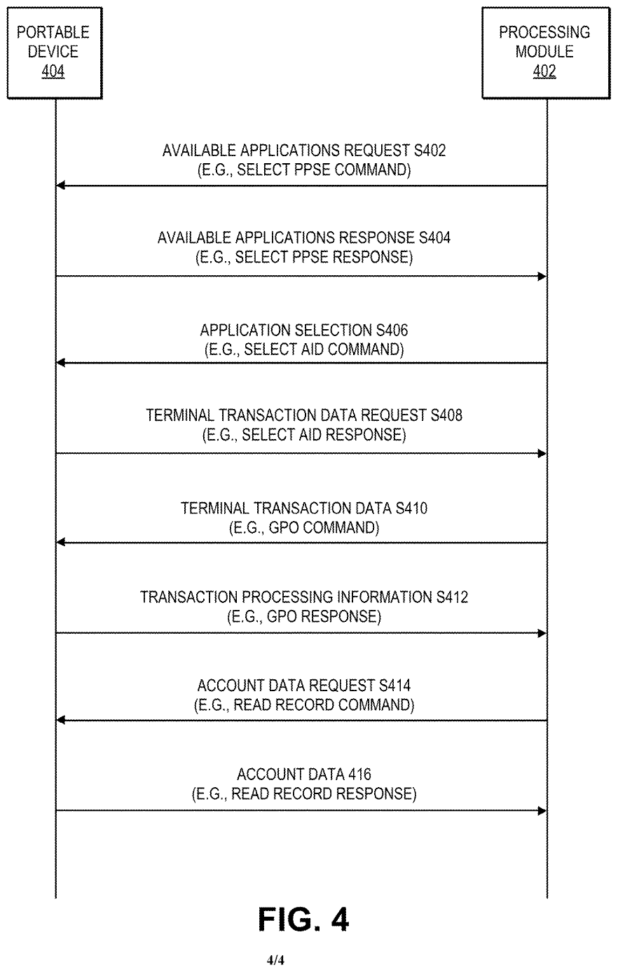

At step 2, after the communication hardware 320 detects the portable device 306, the processing module 316 can initiate communications with the portable device via the communication API 318 and the communication hardware 320. For example, the processing module 316 can exchange APDUs with the portable device 306, for example, SELECT PPSE, SELECT VISA AID, GET PROCESSING OPTIONS and READ RECORD command(s) and response(s). Further details regarding these types of messages are described below with respect to FIG. 4. During this data exchange, the processing module 316 can obtain interaction data from the portable device. For example, the portable device 306 can provide interaction data to the user device 310. The interaction data can include a primary account number (PAN), a token, a cryptogram, etc.

The processing module 316 can receive the application data from the resource provider application and the interaction data (e.g., EMV card, terminal data (e.g., PAN/Token, ARQC cryptogram), etc.) from the portable device 306. The processing module 316 can also perform any suitable user verification and data encryption processes associated with the application data and/or the interaction data.

At step 3, the processing module 316 can generate an authorization request message based on the application data and/or the interaction data. For example, the application data can include one or more data elements (e.g., application data elements) and the interaction data can include one or more data elements (e.g., interaction data elements). The processing module 316 can include any suitable number of application data elements and/or interaction data elements into the authorization request message. For example, the authorization request message can include application data elements (e.g., amount, resource provider identifier, etc.) and interaction data elements (e.g., token, cryptogram, etc.).

The processing module 316 can provide the authorization request message to the processing system 308. In some embodiments, the processing module 316 can provide the authorization request message to the processing system 308 that includes a gateway (e.g., a payment gateway) over a wireless communication channel of the user device 310. A gateway may be a server computer that facilitates information from a payment portal to another processing entity. For example, the gateway may transfer information received from user device 310 to a network processing computer in the processing system 308.

In other embodiments, the processing module 316 of the user device 310 can provide the authorization request message to the processing system 308 that includes a kernel-in-cloud (KiC) server over a wireless communication channel. In such embodiments, the functionality of the processing module 316 can be present in the processing system 308 instead of the user device 310, and the user device 310 can have a light application which routes information to and from the processing system 308. Further details regarding kernel in the cloud processing can be found in U.S. Pat. No. 10,588,016, which is assigned to the same assignee as the present application. In some embodiments, the authorization request message that passes from the user device 310 to the processing system 308 can be in one format (e.g., an HTTPs or other data format), and the processing system 308 can re-format the authorization request message (e.g., to an ISO 8583 message format) and/or add additional data elements to it, before transmitting it to an authorizing entity computer for approval.

At step 4, the processing system 308 can process the authorization request message. For example, in some embodiments, a gateway can receive the authorization request message and provide the authorization request message to a transport computer that forwards the authorization request message to a network processing computer. The network processing computer can provide the authorization request message to an authorizing entity computer. The authorizing entity computer can determine whether or not to authorize the interaction associated with the authorization request message. The authorizing entity computer can generate an authorization response message comprising an indication of whether or not the interaction is authorized. The authorizing entity computer can provide the authorization response message to the user device 310 via the network processing computer, the transport computer, and the gateway.

In other embodiments, at step 4, the processing system 308 can be a remote computer as described in U.S. Pat. No. 10,588,016. The processing system 308 can perform any suitable processing described therein.

At step 5, after receiving the authorization response message from the processing system 308, the processing module 316 can provide the interaction result(s) (e.g., the indication of whether or not the interaction is authorized, the authorization response message, and/or any other data derived from the authorization response message) to the resource provider application A 312.

At step 6, after receiving the interaction results, the resource provider application A 312 can provide the interaction results to the resource provider server 304.

At step 7a, after receiving the interaction results, if the interaction results indicate that the interaction is authorized, the resource provider server 304 can provide the interaction results and/or data derived therefrom (e.g., an indication to provide resources associated with the authorized interaction to the user of the user device 310 to the resource provider device 302. Once the delivery person operating the resource provider device 302 receives the indication that the interaction is authorized, then delivery person can provide the requested resource (e.g., food, a package, etc.) to the user of the user device 310.

In some embodiments, at step 7b, the resource provider application A 312 on the user device 310 can communicate directly (e.g., over a local communication channel) to resource provider device 302 regarding the completion of the interaction. For example, the resource provider application A 312 can display a QR code on a display of the user device 310. The operator of the resource provider device 302 (e.g., a resource delivery person) can scan the QR code on the user device 310 with a scanner or camera on the resource provider device 302. Upon scanning the QR code, the resource provider device 302 can prompt the operator to provide the resources (or not to provide the resources) to the user of the user device 310.

At the end of the day or at any other suitable time, a clearing and settlement process can occur between the authorizing entity associated with the credential associated with the portable device 306, an acquirer associated with the resource provider operating the resource provider server 304, and a payment processing network.

As an illustrative example of the process described in FIG. 3, a user can utilize the resource provider application A 312 on the user device 310 to initiate a transaction to receive resources. For example, the user can submit an order for resources on the resource provider application A 312 while at their home and connected a communication channel (e.g., Wi-Fi that provides a stable wireless connection for online authorization). The user can select to tap and pay on the user device 310 at the time of delivery instead of providing the user's PAN to the resource provider application A 312 or paying cash on delivery.

At some later point in time, a delivery personnel can deliver the resources to user's location. The user can examine the delivered resources and then select a tap and pay button in the resource provider application A 312. The user device 310 can prompt the user to tap the portable device 306 on the user device (e.g., bring into short-range communication). The portable device 306 data (e.g., interaction data) can be processed along with the resource provider application A 312 data (e.g., application data) by the processing module 316 of the user device 310.

The user device 310 can generate an authorization request message based on the application data and the interaction data and then provide the authorization request message to a processing system. For example, the authorization request message can be processed by a gateway, a transport computer, a network processing computer, and an authorizing entity computer. The authorizing entity computer can determine whether or not to authorize the interaction for the resources, and then generate an authorization response message indicating whether or not the interaction is authorized.

The user device 310 can receive the authorization response message at the processing module 316. The processing module 316 can provide the authorization response message to the resource provider application A 312, which is herein incorporated by reference and is assigned to the same assignee as the present application. The resource provider application A 312 can then complete the interaction and generate a QR code, which may be displayed on the user device 310. The delivery personnel can scan the QR code on the user device 310 using the resource provider device 302 and then, if the interaction is authorized, provide the resources to the user.

As an additional example of the process described in FIG. 3, a user can order food in the resource provider application B 314 on the user device 310 (or alternatively on a resource provider or merchant Website) and can check out for the interaction in the user's location when connected to, for example, Wi-Fi. The user can select to tap and pay on the user device 310 at the time of order instead of providing the portable device's 306 PAN to the resource provider application B 314 or paying cash on delivery. The user can then bring the portable device 306 into short-range communication with the user device 310. The interaction data and the application data can be processed as described herein. The user device 310 can receive an authorization response message from the processing system 308.

The authorization response message can be provided by the processing module 316 of the user device 310 to the resource provider application B 314. The resource provider application B 314 can then provide the authorization response message and any other suitable data (e.g., application data) to the resource provider server 304. Upon receiving the authorization response message and/or the application data, the resource provider server 304 can prompt the resource provider to prepare the food order for the user in any suitable manner. A delivery person can then deliver the food to the user's location. The user can confirm the food delivery in the resource provider application B 314 on the user device 310.

As an additional example of the process described in FIG. 3, a user can select to a home cleaning service in a resource provider application C (not shown in FIG. 3) on the user device 310 when connected to a cellular data service. At any suitable point in time thereafter, service personnel can receive the service request via the resource provider server 304 and resource provider device 302 operated by the service personnel. The service personnel can go to the user's location (e.g., a home address provided by the user to the resource provider application C). The service personnel can enter the user's home, for example, using a one-time code provided by an access control system. For example, the one-time code can be created by the user and provided to the resource provider application C. In some embodiments, the one-time code can be created by the resource provider application C on behalf of the user.

The service personnel can complete the home cleaning service and then enter an amount in a resource provider application C stored on the resource provider device 302. The resource provider application C on the resource provider device 302 can be the same, or similar, to the resource provider application C on the user device 310. The amount and/or an indication of completion of the service can be provided from the resource provider device 302 (e.g., via the resource provider application C) to the resource provider server 304. The resource provider server 304 can provide the amount and the indication of the completion of the service to the resource provider application C on the user device 310.

The resource provider application C on the user device 310 can receive the completion notice and then prompt the user to complete the interaction (e.g., pay for the provided service). The user can make a selection on the user device 310 regarding how to complete the interaction with the resource provider application C. For example, the user can select to complete the interaction using the portable device 306 by retrieving interaction data from the portable device 306. As such, the user device 310 can prompt the user to bring the portable device 306 into short-range communication with the user device 310. As such, the interaction data can be provided from the portable device 306 to the processing module 316 of the user device 310, rather than providing the interaction data to the resource provider application C. The interaction data and application data can be processed by the processing module 316 and the processing system 308 as described herein.

The user device 310 can receive an authorization response message from the processing system 308 including an indication of whether or not the interaction is authorized. After receiving the authorization response message, the processing module 316 can provide the authorization response message to the resource provider application C. The resource provider application C can then complete the interaction and can send a notification indicating completion (e.g., the authorization response message) to the resource provider server 304. The resource provider server 304 can then provide the authorization response message and/or any other suitable data to the resource provider device 302. After receiving an indication of whether or not the interaction is authorized, the service personnel can lock front door and leave the user's home.

FIG. 4 illustrates an example communication flow between a portable device 404 and a processing module 402 according to some embodiments. The processing module 402 can be in user device, which is not illustrated for clarity of illustration. The steps in FIG. 4 can occur in step 2 in the flow described above with respect to FIG. 3.

Processing module 402 can be emulated, for example, based on an access device profile such as an actual point of sale (POS) terminal. The communications between the processing module 402 and the portable device 404 can be in the form of application commands sent from processing module 402 and application data responses sent from portable device 404 in response to the application commands. In some embodiments, the application commands and data responses can be in the form of APDU commands and responses. However, it should be understood that other messages, messaging protocols, or formats can be used to exchange the application data to conduct the transaction.

To initiate the application data exchange, processing module 402 may initiate a transaction by sending an available applications request S402 to portable device 404 to request information as to which payment application identifier(s) (AID(s)) may be available. Each AID may correspond to an account of the user and/or processing options associated with an account. In some embodiments, the available application(s) request S402 may be in the form of a select PPSE command. The available applications request S402 may include a payment environment identifier (e.g., a PPSE name) to identify the payment environment supported by processing module 402.

Upon receiving the available applications request S402, portable device 404 may identify and process the request by recognizing the payment environment identifier (e.g., PPSE name) included in the request, and respond by sending an available applications response S404 back to processing module 402. The available applications response S404 may include a list of available AIDs, and may include the payment environment identifier (e.g., PPSE name) as the dedicated file name. In some embodiments, the available applications response S404 may be in the form of a select PPSE response and may include PPSE file control information (FCI). For example, the available applications response S404 may include a directory entry for each available AID. If portable device 404 supports only one AID, portable device 404 may respond with a single directory entry for the supported AID. If portable device 404 supports an account with multiple AIDs, the transaction application may respond with a directory entry for each of the supported AIDs. Each directory entry may include information such as the AID, an application label associated with the AID (e.g., a mnemonic associated with the AID), an application priority indicator indicating the priority of the AID, a kernel identifier indicating the application's kernel preference, and/or additional information relating to the particular AID. The available application(s) response S404 may also include other data such as FCI issuer discretionary data.

When processing module 402 receives the available applications response S404, processing module 402 may select a suitable application from the list of applications received in the available applications response S404 (e.g., by selecting an AID from the available AID(s) received in the available application(s) response S404). In some embodiments, the selected AID can be the highest priority AID on a prioritized list of application identifiers supported by the access device being emulated by processing module 402. The prioritized list of application identifiers can be obtained as part of the access device profile. Processing module 402 may send an application selection S406 with the selected AID to portable device 404 to continue the transaction. In some embodiments, the application selection S406 can be in the form of a select AID command.

Upon receiving the application selection S408, portable device 404 may send a terminal transaction data request 408 to request transaction data from processing module 402 to execute the transaction using the selected application/AID. In some embodiments, the terminal transaction data request S408 may be in the form of a select AID response and may include AID file control information (FCI) with the selected AID as the dedicated file name. The terminal transaction data request S408 may include a list of transaction data identifiers to request the appropriate data from processing module 402, and the list of transaction data identifiers can be in the form of a processing options data object list (PDOL). The transaction data requested by portable device 404 for the transaction may include terminal transaction qualifiers (TTQ), authorized amount, other amount, terminal country code, terminal verification results, transaction currency code, transaction data, transaction type, and/or an unpredictable number. The terminal transaction data request 408 may also include other data such as FCI issuer discretionary data, application program identifier, and language preference.

After receiving the terminal transaction data request 408, processing module 402 may send to portable device 404, the terminal transaction data S410 requested by portable device 404. The terminal transaction data S410 provided by processing module 402 can be obtained from the previously described resource provider application. In some embodiments, the terminal transaction data 410 may be sent in the form of a get processing options (GPO) command, and may include the requested terminal transaction data in a processing options data object list (PDOL). In some embodiments, the terminal transaction data S410 (e.g., terminal transaction qualifiers (TTQ)) may include a transaction type indicator indicating the type of transaction supported by the access device. In some embodiments, the terminal transaction data S410 (e.g., terminal transaction qualifiers (TTQ)) may also include a consumer verification method (CVM) requirement indicator to indicate whether a CVM is required by the access device for the transaction, and also one or more CVM type indicators indicating the types of CVM supported by the access device. Examples of CVMs that may be supported by the access device can include online PIN, signature, and/or consumer device CVM (CDCVM) such as a passcode to unlock the screen or portable device 404.

Once the portable device 404 receives terminal transaction data S410, portable device 404 may increment its Application Transaction Counter (ATC), generate dynamic transaction processing information using at least some of the received terminal transaction data 410, and send a set of transaction processing information S412 including the generated dynamic transaction processing information to processing module 402. In some embodiments, the transaction processing information S412 can be sent in the form of a GPO response. In some embodiments, the transaction processing information S412 may include one or more application file locators (AFLs) that can be used as file address(es) by processing module 402 to read account data stored on portable device 404, and an application interchange profile (AIP) that can be used to indicate the capabilities of portable device 404.

In some embodiments, the AFLs included in transaction processing information S412 may include file addresses to read account data such as a transaction cryptogram dynamically generated using a limited-use key (LUK) and/or unpredictable number from the access device, track-2 equivalent data including a token or a PAN, and addition data such as issuer application data (IAD), form factor indicator (FFI), card transaction qualifiers (CTQ), cryptogram information data (CID), the updated ATC, and/or an application PAN sequence number (PSN). In some embodiments, the issuer application data (IAD) may include a length indicator indicating the length of the IAD, cryptogram version number (CVN) indicating the version of the transaction cryptogram, a derived key indicator (DKI) that can be used to identify a master key (e.g. a master key associated with the issuer used in generation of the LUK), card verification results (CVR), a wallet provider ID, and/or derivation data such as the key index that was used in the generation of the LUK. In some embodiments, transaction processing information S412 may include the above account data themselves instead of their corresponding AFLs, or a combination thereof. It should also be understood that in some embodiments, the transaction processing information S412 being sent from portable device 404 to processing module 402 may include some or all of the information describe above, and in some embodiments, may include additional information not specifically described.

After processing module 402 receives the transaction processing information S412, processing module 402 may send an account data request S414 to portable device 404 to read additional account data that may be stored on the portable device 404. In some embodiments, the account data request S414 may be in the form of a read record command, and may include an application file locator (AFL) indicating the location of the account data that processing module 402 is attempting to read. The AFL included in the account data request S414 may correspond to an AFL in the transaction processing information S412 that was provided to processing module 402 from portable device 404.

In response to receiving the account data request S414 from processing module 402, portable device 404 may send the account data 416 stored at the location indicated by the AFL to processing module 402. In some embodiments, the account data 416 may be sent in the form of a read record response. The account data 416 may include, for example, the account data elements discussed above (e.g., a PAN, token, CVV, etc.), and/or application usage control that indicates the issuer's restrictions on the usage and services allowed for the application, the cardholder's name, customer exclusive data, issuer country code, token requester ID (e.g., if a token is used), and/or other account related data that is accessible at the AFL location. It should be understood that in some embodiments, the account data 416 being sent from portable device 404 to processing module 402 may include some or all of the information describe above, and in some embodiments, may include additional information not specifically described.

Once processing module 402 has received the requisite data from the transaction processing information S412 and/or one or more account data 416 transmissions, some or all of the data elements in the transaction processing information S412 and/or one or more account data 416 transmissions can be concatenated by processing module 402 to form a data packet. The data packet may include a checksum and a packet length indicator to indicate the length of the data packet. The data packet can be used by the processing module to generate a transaction authorization request message to request authorization of the transaction from the issuer. For example, in some embodiments, the transaction authorization request message may include at least the track-2 equivalent data including a token or PAN, and the transaction cryptogram generated with the LUK, and the transaction can be authorized based on at least verifying that the transaction cryptogram was generated correctly and that the LUK used in generation of the transaction cryptogram has not exhausted the LUK's set of one or more limited use thresholds.

Embodiments of the disclosure have a number of advantages. For example, one or more different resource provider applications can be stored on the user device 310, while each resource provider application utilizes the processing module. As such, the resource provider applications can be thin clients, or may be lightweight as they do not need to include the processing module capabilities.

Embodiments of the disclosure have a number of additional advantages. For example, embodiments provided for additional security compared to prior methods. Previously, resource provider applications, after receiving a selection to perform an interaction from the user, would prompt the user to provide interaction data to the resource provider application (e.g., via manually entry of a PAN, or by allowing the resource provider application to communicate with the user's portable device). As such, the resource provider application could receive the interaction data, thus putting the user's secure interaction data (e.g., credentials) at risk (e.g., because the resource provider application is potentially malicious or is unable to protect the interaction data). Embodiments solve this problem by having a processing module of the user device communicate with the portable device, while not providing the interaction data to the resource provider application.

Furthermore, since the resource provider applications do not receive the interaction data, the resource provider applications can have fewer security requirements, thus making it easier to develop and/or evaluate the resource provider applications. Additionally, the user of the user device can be more confident with tapping their own portable device on their own user device, rather than risking providing interaction data to a malicious resource provider device operated by a malicious delivery personnel, for example. Embodiments of the disclosure have a number of additional advantages, for example, the user need not manually enter a credential into their user device.

Embodiments of the disclosure have a number of additional advantages. For example, the processing module can run as a single instance on a single user device, thus making it easier to maintain, upgrade, and fix errors, which would previously be spread across a plurality of resource provider applications.

Embodiments of the disclosure also allow for the portable device to be present during the transaction. As such, fewer fraudulent attempts to perform an interaction with the user's PAN associated with the portable device may be performed by a fraudulent party. Due to there being fewer fraudulent attempts, various interchange rates can be lowered for entities that perform embodiments.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
providing an API call from a resource provider application on a user device to a processing module on the user device, wherein the API call includes application data for an interaction;
prompting, by the user device, a user to bring a portable device into communication range with the user device, based on the application data;
receiving, by the user device, interaction data from the portable device;
generating, by the user device, an authorization request message based on the application data and/or the interaction data;
providing, by the user device, the authorization request message to a processing system, wherein the processing system obtains an authorization response message comprising an indication of whether or not the interaction is authorized;
receiving, by the user device, the authorization response message; and
providing, by the user device, the indication of whether or not the interaction is authorized from the processing module to the resource provider application.

2. The method of claim 1, wherein the API call further includes an API key and a certificate, and wherein the processing module validates the API key and the certificate before allowing the resource provider application to further interact with the processing module.

3. The method of claim 1 further comprising:
determining, by the user device using the processing module, whether or not to prompt the user to bring the portable device into the communication range based on the application data of the API call.

4. The method of claim 1, wherein the communication range is short-range communication.

5. The method of claim 1 further comprising:
providing, by the user device, the indication of whether or not the interaction is authorized from the resource provider application to a resource provider server associated with the resource provider application, wherein the resource provider server provides the indication of whether or not the interaction is authorized to a resource provider device.

6. The method of claim 1, wherein the interaction data is not provided to the resource provider application.

7. The method of claim 1, wherein the interaction data comprises a credential or a token, wherein the credential or the token is stored on the portable device.

8. The method of claim 1, wherein the user device is a mobile phone.

9. The method of claim 1 further comprising:
providing, by the user device, the indication of whether or not the interaction is authorized from the resource provider application to a resource provider device, which authorizes delivery person to provide a requested resource to the user.

10. The method of claim 1, wherein the portable device is a contactless card.

11. The method of claim 1, wherein the API call further includes an API key and a certificate, and wherein the method further comprises:
validating, by the resource provider application, the API key and the certificate before prompting the user to bring the portable device into communication range with the user device.

12. The method of claim 1, wherein the application data comprises a value for the interaction, and a resource provider identifier, and the interaction data comprises a credential or token, and a cryptogram based on at least the value.

13. The method of claim 1, wherein the user device and the portable device communicate with each other via NFC (near field communications).

14. The method of claim 1, further comprising:
generating, by the resource provider application, a QR code based upon the indication of whether or not the interaction is authorized; and
presenting, by the user device, QR code to a resource provider device, which displays a message to a delivery person to provide a requested resource to the user.

15. A user device comprising:
a processor; and
a computer readable medium coupled to the processor, the computer readable medium comprising code, executable by the processor, to implement a method comprising:
providing an API call from a resource provider application on the user device to a processing module on the user device, wherein the API call includes application data for an interaction;
prompting a user to bring a portable device into communication range with the user device, based on the application data;
receiving interaction data from the portable device;
generating an authorization request message based on the application data and/or the interaction data;
providing the authorization request message to a processing system, wherein the processing system obtains an authorization response message comprising an indication of whether or not the interaction is authorized;
receiving the authorization response message; and
providing the indication of whether or not the interaction is authorized from the processing module to the resource provider application.

16. The user device of claim 15, wherein the user device is a mobile phone.

17. The user device of claim 15, wherein the user device comprises a long range antenna coupled to the processor.

18. The user device of claim 15, wherein the user device further comprises communication hardware adapted to communicate with the portable device via a short range wireless communication protocol or a contact communication protocol.

19. The user device of claim 15, wherein the computer readable medium comprises a plurality of resource provider applications, each resource provider application providing interaction data to the processing module to conduct transactions.

20. The user device of claim 19, wherein each resource provider application in the plurality of resource provider applications does not send and does not communicate with a resource provider server computer to send authorization request messages to authorize interactions.
